(19) United States
(12) Patent Application Publication
(10) Pub. No.: US 2020/0290209 A1
(43) Pub. Date: Sep. 17, 2020

(54) CONTROL DEVICE FOR ROBOT

(71) Applicant: Honda Motor Co.,Ltd., Tokyo (JP)

(72) Inventor: Taizo YOSHIKAWA, Saitama (JP)

(73) Assignee: Honda Motor Co.,Ltd., Tokyo (JP)

(21) Appl. No.: 16/809,579

(22) Filed: Mar. 5, 2020

(30) Foreign Application Priority Data
Mar. 12, 2019 (JP) 2019-045021

(51) Int. Cl. B25J 11/00; B25J 9/00; B25J 9/16

(52) U.S. Cl. CPC B25J 11/009; B25J 9/1694; B25J 9/0006

(57) ABSTRACT

A control device for a robot that can decrease damage when the robot falls forward or rearward and can be applied to an assist robot is provided. A controller 20 of a control device 1 determines whether a robot 2 is in a fall start state in which the robot starts to fall in one of a forward direction and a rearward direction based on detection signals from sensors 21 to 23 (STEP10 to STEP20), performs knee joint control such that a part in the one direction of a knee joint and a hip joint comes into contact with a walking surface (STEP45 and STEP63), and performs hip joint control such that the center of gravity GC_u of an upper body moves in the direction opposite to the one direction (STEP46 and STEP6 4) when it is determined that the robot 2 is in the fall start state.

### CROSS-REFERENCE TO RELATED APPLICATION

This application claims the priority of Japan patent application serial no. 2019-045021, filed on Mar. 12, 2019. The entirety of the above-mentioned patent application is hereby incorporated by reference herein and made a part of this specification.

### BACKGROUND

### Technical Field

The disclosure relates to a control device for a robot that controls a posture of the robot when the robot falls forward or rearward.

### Description of Related Art

In the related art, a control device for a robot which is described in Patent Document 1 is known. In such a control device, three-point-support fall control is performed to decrease damage when a humanoid robot falls forward. In this three-point-support fall control, motion states of joint actuators are controlled such that a motion of stepping forward and a motion of bending an upper body of the humanoid robot forward are simultaneously performed. Accordingly, the robot assumes a posture in which two legs and a hand are in contact with a walking surface and enters a three-point supported state, whereby damage when the robot falls forward is decreased.

### PATENT DOCUMENTS

[Patent Document 1] Japanese Patent Laid-Open No. 2014-180748

In the control device according to the related art, since kinetic energy based on a moment of an upper body of the robot acts on an arm via the walking surface, there is a problem in that a degree of decrease in damage is not satisfactory. Since only control when the humanoid robot falls forward is considered, there is a problem in that control when the humanoid robot falls rearward should also be considered. In addition, it cannot be applied to a robot other than a humanoid robot, for example, a walk assisting robot which is attached to a user to support a walking motion of a user who is a human being, or the like.

The disclosure provides a control device for a robot that can decrease damage when the robot falls forward or rearward and be applied to an assist robot.

### SUMMARY

According to a first embodiment of the disclosure, there is provided a control device 1 for a robot 2, the robot including a base body 3 having a hip, a lower leg portion extending from the base body 3 via a hip joint (a hip joint mechanism 14) and having a movable link (a leg link 4) including a knee joint (a knee joint mechanism 15), a hip joint driving part (a joint actuator 25), and a knee joint driving part (a joint actuator 25) and being able to perform a walking motion for walking on a walking surface by driving the hip joint and the knee joint using the hip joint driving part and the knee joint driving part, the control device including: a motion state acquiring unit (a foot pressure sensor 21, a motion sensor 22, a joint angle sensor 23) configured to acquire motion states of the base body and the lower leg portion; a determination unit (a controller 20, STEP10 to STEP20) configured to determine whether the robot 2 is in a fall start state in which the robot starts to fall in one direction of a forward direction and a rearward direction on the basis of a result of acquisition of the motion states by the motion state acquiring unit; a knee joint control unit (a controller 20, STEP45 and STEP53) configured to perform a knee joint control for controlling a knee joint angle which is a joint angle of the knee joint via the knee joint driving part such that a portion of the one direction side of the knee joint and the hip comes into contact with the walking surface when it is determined that the robot 2 is in the fall start state in the one direction; and a hip joint control unit (a controller 20, STEP46 and STEP64) configured to perform a hip joint control for controlling a hip joint angle which is a joint angle of the hip joint via the hip joint driving part such that a center of gravity of an upper part (the center of gravity GC_u of an upper body) which includes the base body 3 and which is higher than the base body 3 moves in a direction opposite to the one direction after the knee joint control has started.

### BRIEF DESCRIPTION OF THE DRAWINGS

FIG. 1 is a diagram schematically illustrating a configuration of a robot to which a control device according to an embodiment of the disclosure is applied;

FIG. 2 is a block diagram illustrating an electrical configuration of the control device;

FIG. 3 is a flowchart illustrating a motion control process;

FIG. 4 is a flowchart illustrating a fall start determining process;

FIG. 5 is a flowchart illustrating a falling-on-knee motion control process;

FIG. 6 is a flowchart illustrating a falling-on-hips motion control process;

FIG. 7 is a flowchart illustrating a data calculating process;

FIG. 8 is a diagram illustrating change of a posture when a robot starts a forward fall from a standing posture supported by two legs and the falling-on-knee motion control process is performed;

FIG. 9 is a diagram illustrating change in posture when a robot starts a forward fall from a posture supported by one leg during walking forward and the falling-on-knee motion control process is performed;

FIG. 10 is a diagram illustrating change of a posture when a robot starts a rearward fall from a standing posture supported by two legs and the falling-on-hips motion control process is performed;

FIG. 11 is a diagram illustrating change in posture when the final posture control process is performed while the falling-on-hips motion control process is being performed;

FIG. 12 is a diagram illustrating change in posture when the center of gravity of a robot moves rearward due to a factor such as an external force while the robot is walking forward;

FIG. 13 is a diagram illustrating change in posture when a robot starts a rearward fall from a posture supported by one leg during walking rearward; and

FIG. 14 is a diagram illustrating change in posture when a user who wears an assist robot starts a rearward fall from a standing posture supported by two legs and the falling-on-hips motion control process is performed.

### DESCRIPTION OF THE EMBODIMENTS

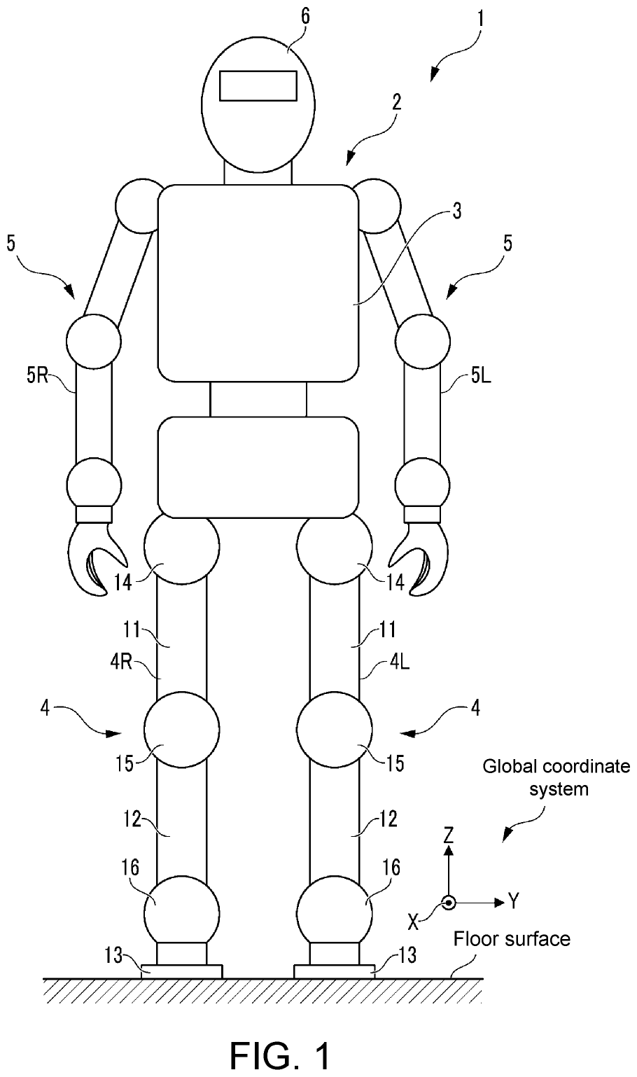

Hereinafter, a control device for a robot according to an embodiment of the disclosure will be described with reference to the accompanying drawings. As illustrated in FIG. 1, the control device 1 according to this embodiment is applied to a humanoid robot 2, and this robot 2 will be first described below.

The robot 2 includes a base body 3, a pair of leg links 4L and 4R, a pair of arm links 5L and 5R, and a head 6. In the following description, the left and right leg links 4L and 4R are appropriately collectively referred to as leg links 4 (movable links) and the left and right arm links 5L and 5R are also appropriately collectively referred to as arm links 5.

The base body 3 constitutes an upper body (an upper part) of a hip of the robot 2 and up, the head 6 is attached to a top end of the base body 3 via a neck joint mechanism, and each leg link 4 extends from the bottom end of the base body 3.

Each leg link 4 is constituted by connecting element links corresponding to an upper leg 11, a lower leg portion 12, and a foot 13 sequentially downward from the base body 3 side via a hip joint mechanism 14, a knee joint mechanism 15, and an ankle joint mechanism 16. In this embodiment, the hip joint mechanism 14 corresponds to a hip joint and the knee joint mechanism 15 corresponds to a knee joint.

In this embodiment, each leg link 4 is configured, for example, to have six degrees of freedom of motion by the joint mechanisms 14, 15, and 16 between the foot 13 and the base body 3.

For example, the hip joint mechanism 14 is constituted by three joints (not illustrated) such that it has a total of three degrees of freedom of rotation of three axes. The knee joint mechanism 15 is constituted by a single joint (not illustrated) such that it has one degree of freedom of rotation of one axis. The ankle joint mechanism 16 is constituted by two joints (not illustrated) such that it has a total of two degrees of freedom of rotation of two axes.

Each arm link 5 extends from an upper part of the base body 3. Each arm link 5 is constituted by connecting element links corresponding to an upper arm, a lower arm, and a hand sequentially from the base body 3 side via a shoulder joint, an elbow joint, and a wrist joint.

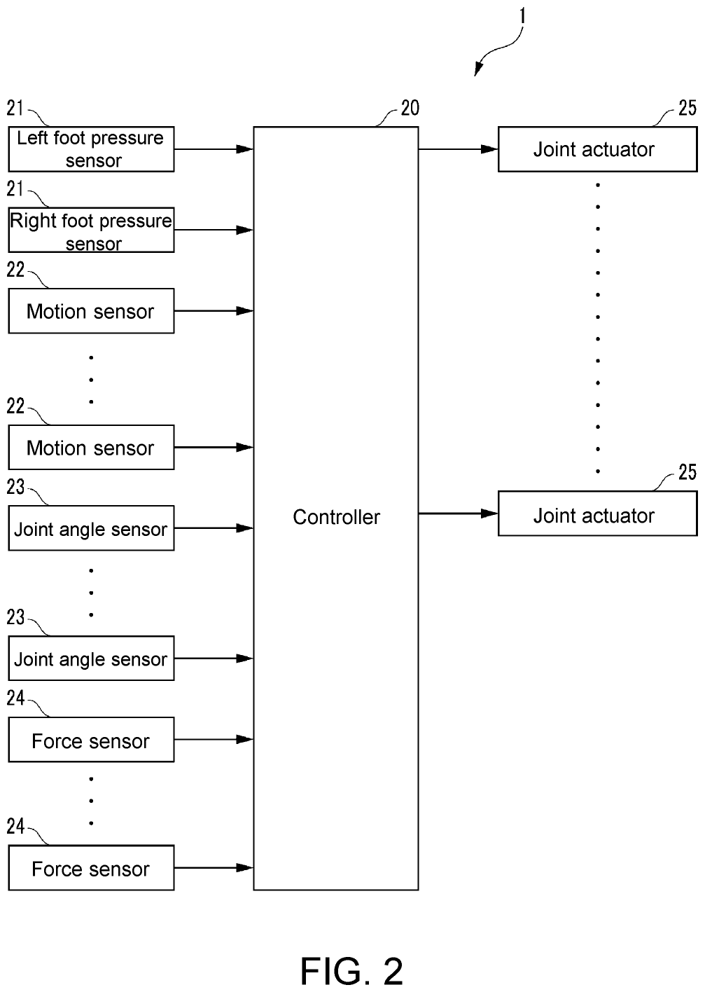

On the other hand, as illustrated in FIG. 2, the control device 1 includes a controller 20, left and right foot pressure sensors 21 and 21, a plurality of motion sensors 22, a plurality of joint angle sensors 23, a plurality of force sensors 24, and a plurality of joint actuators 25.

In this embodiment, the controller 20 corresponds to a determination unit, a knee joint control unit, a hip joint control unit, a contact time estimating unit, a second knee joint control unit, and a second hip joint control unit. The foot pressure sensors 21, the motion sensors 22, and the joint angle sensors 23 correspond to a motion state acquiring unit, and the joint actuators 25 correspond to a hip joint driving part and a knee joint driving part.

The left and right foot pressure sensors 21 and 21 are incorporated into the bottoms of the left and right feet 13 and 13, and serve to detect pressures acting on the bottoms of the left and right feet 13 and 13 and to output detection signals indicating the detected pressures to the controller 20.

The plurality of motion sensors 22 is provided at a plurality of positions including soles of the left and right feet 13 and 13, the waist (a lower part of the base body 3), and the head 6. Each motion sensor 22 is constituted as a type of an inertial measurement unit and serves to detect acceleration in directions of three axes (x, y, and z axes), rotational angles in the directions of the three axes, and terrestrial magnetism in the directions of the three axes at its installation position and to output detection signals indicating the detection results to the controller 20.

The plurality of joint angle sensors 23 is provided in joint mechanisms including the joint mechanisms 14 to 16. Each joint angle sensor 23 is constituted by, for example, an encoder and serves to detect a joint angle which is an angle of a joint mechanism and to output a detection signal indicating the detected joint angle to the controller 20.

On the other hand, each of the plurality of force sensors 24 is constituted by, for example, a six-axis force sensor and is provided in the joint mechanisms or the like. Each force sensor 24 detects a combination of a three-dimensional translational force vector and a three-dimensional moment vector as a contact reaction force acting on the tips of the leg links 4 and the arm links 5 and outputs a detection signal indicating the detected combination to the controller 20.

The plurality of joint actuators 25 is provided in each joint mechanism and each is constituted by, for example, a combination of an electric motor and a drive mechanism. In this case, the angle of the hip joint mechanism 14, that is, a hip joint angle, is changed by the joint actuator 25 which is provided in the hip joint mechanism 14, and the angle of the knee joint mechanism 15, that is, a knee joint angle, is changed by the joint actuator 25 which is provided in the knee joint mechanism 15.

The controller 20 is constituted by an electronic circuit unit including a CPU, a RAM, a ROM, and an I/O interface circuit and is incorporated into the base body 3 of the robot 2. The controller 20 performs a motion control process on the basis of the detection signals from the various sensors 21 to 24 as will be described below.

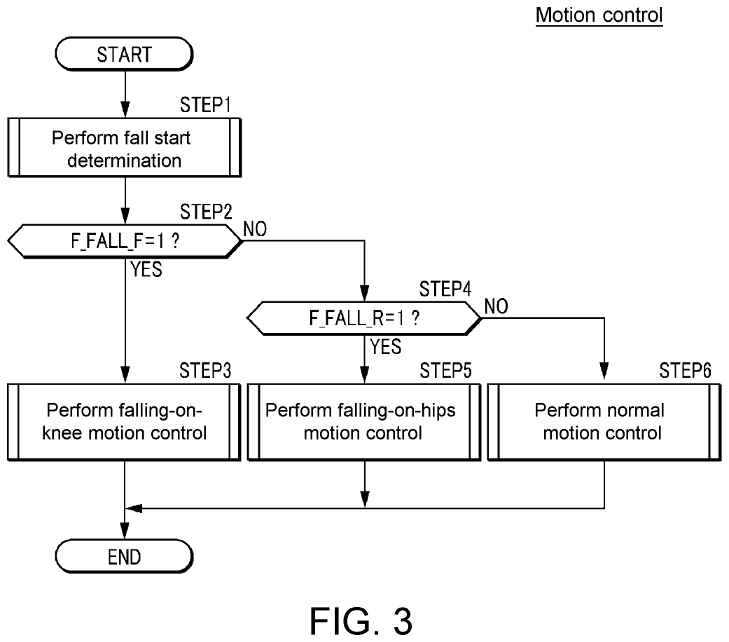

A motion control process will be described below with reference to FIG. 3. This motion control process includes controlling a motion of the robot 2 on the basis of the detection signals from the sensors 21 to 24 and is performed at intervals of a predetermined control period ΔT by the controller 20.

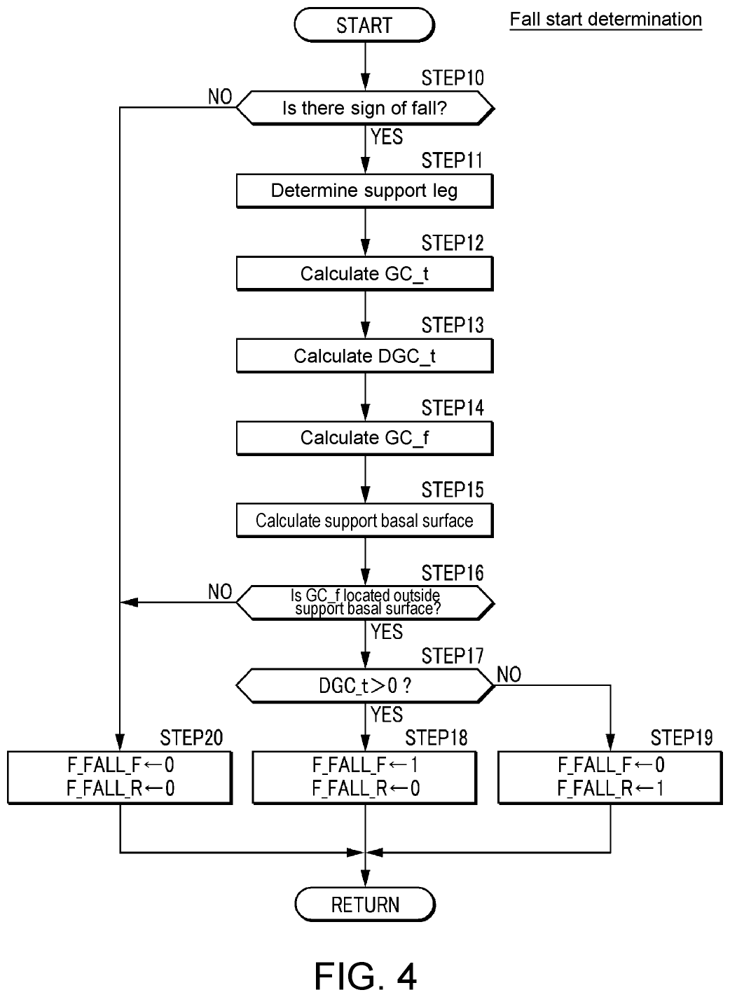

As illustrated in FIG. 3, in the motion control process, first, a fall start determining process is performed (STEP1 in FIG. 3). The fall start determining process includes determining whether the robot 2 is in a state (a posture) in which the robot starts a forward or rearward fall and is specifically performed as illustrated in FIG. 4.

As illustrated in the drawing, first, it is determined whether there is a sign of a fall of the robot 2 (STEP10 in FIG. 4). This determination is performed on the basis of the result of estimation of the posture of the robot 2 using a predetermined estimation technique on the basis of the detection signals from the sensors 21 to 24.

When the determination result is negative (NO in STEP10 in FIG. 4), it is determined that the robot 2 is not in the fall start state, a forward fall start state flag F_FALL_F and a rearward fall start state flag F_FALL_R are both set to “0” in order to indicate the determination result (STEP20 in FIG. 4), and this process flow is ended.

On the other hand, when the determination result is positive (YES in STEP10 in FIG.

4) and there is a sign of a fall of the robot 2, a support leg determining process is performed. The support leg determining process includes determining whether the robot 2 is supported by two legs or by one of the left and right legs, and is performed on the basis of the detection signals from the motion sensors 22 of the left and right feet 13 and 13.

Specifically, on the basis of positions in a Z-axis direction (hereinafter referred to as “Z-axis positions”) of the left and right feet 13 and 13, it is determined that the robot is supported by the right leg when the Z-axis position of the left foot is higher than that of the right foot 13, it is determined that the robot is supported by the left leg when the Z-axis position of the right foot 13 is higher than that of the left foot 13, and it is determined that the robot is supported by two legs otherwise.

After the support leg determination process has been performed as described above, the total center of gravity GC_t of the robot 2 is calculated on the basis of the result of determination of a support leg and the detection signals from the sensors 22 and 23 (STEP12 in FIG. 4). The total center of gravity GC_t corresponds to the center of gravity of the robot 2 as a whole.

Subsequently, a rate of change DGC_t of the total center of gravity of the robot 2 is calculated using Equation (1) (STEP13 in FIG. 4).

DGC_t(k)={GC_t(k)−GC_t(k−1)}/ΔT (1)

Discrete data with a sign (k) in Equation (1) represents data which is calculated in synchronization with the predetermined period ΔT, and the sign k (where k is a positive integer) represents the order of calculation cycles of discrete data. For example, the sign k represents a current value which is calculated at the current calculation time, and the sign k−1 represents a previous value which has been calculated in the previous calculation time. This is true of following discrete data. In the following description, the sign (k) in discrete data will be appropriately omitted.

Then, a predicted center of gravity GC_f is calculated (STEP14 in FIG. 4). This predicted center of gravity GC_f is a predicted position of the center of gravity of the robot 2 as a whole at a future control time when the N-th control period ΔT has elapsed from the current control time, and is calculated using Equation (2).

GC_f(k)=GCt(k)+ΔT·N·DGC_t(k) (2)

The value N in Equation (2) is preset on the basis of responsiveness of control to the balance of the robot 2.

Subsequently, a support basal surface of the robot 2 is calculated (STEP15 in FIG. 4). The support basal surface is calculated on the basis of the result of support leg determination and the detection signals from the sensors 22 and 23.

Subsequently, it is determined whether the predicted center of gravity GC_f is located outside the support basal surface (STEP16 in FIG. 4). In this case, “the predicted center of gravity GC_f is located outside the support basal surface” specifically means that the vertically projected position of the predicted center of gravity GC_f is located outside the support basal surface.

When the result of determination is negative (NO in STEP16 in FIG. 4) and the predicted center of gravity GC_f is located inside the support basal surface, two flags F_FALL_F and F_FALL_R are set to “0” as described above (STEP20 in FIG. 4), and this process flow ends.

On the other hand, when the result of determination is positive (YES in STEP16 in FIG. 4) and the predicted center of gravity GC_f is located outside the support basal surface, it is determined whether DGC_t>0 is satisfied (STEP17 in FIG. 4).

When the result of determination is positive (YES in STEP17 in FIG. 4) and DGC_t>0 is satisfied, it is determined that the robot 2 is in a forward fall start state, and in order to represent this result, the forward fall start state flag F_FALL_F is set to “1” and the rearward fall start state flag F_FALL_R is set to “0” (STEP18 in FIG. 4). Thereafter, the process flow ends.

On the other hand, when the result of determination is negative (NO in STEP17 in FIG. 4), it is determined that the robot 2 is in a rearward fall start state, and in order to represent this result, the forward fall start state flag F_FALL_F is set to “0” and the rearward fall start state flag F_FALL_R is set to “1” (STEP19 in FIG. 4). Thereafter, the process flow ends.

Referring back to FIG. 3, after the fall start determining process (STEP1 in FIG. 3) has been performed as described above, it is determined whether the forward fall start state flag F_FALL_F is set to “1” (STEP2 in FIG. 3).

When the result of determination is positive (YES in STEP2 in FIG. 3) and the robot 2 is in the forward fall start state, a falling-on-knee motion control process (STEP3 in FIG. 3) is performed and then the process flow ends. The falling-on-knee motion control process includes controlling the motion of the robot 2 such that the robot 2 falls on its knee, and details thereof will be described later.

On the other hand, when the result of determination is negative (NO in STEP2 in FIG. 3) and the robot 2 is not in the forward fall start state, it is determined whether the rearward fall start state flag F_FALL_R is set to “1” (STEP4 in FIG. 3).

When the result of determination is positive (YES in STEP4 in FIG. 3) and the robot 2 is in the rearward fall start state, a falling-on-hips motion control process (STEPS in FIG. 3) is performed and then the process flow ends. The falling-on-hips motion control process includes controlling the motion of the robot 2 such that the robot 2 falls on its hips, and details thereof will be described later.

On the other hand, when the result of determination is negative (NO in STEP4 in FIG. 3) and the robot 2 is neither in the forward fall start state nor in the rearward fall start state, a normal motion control process is performed (STEP6 in FIG. 3), and then the process flow ends. In the normal motion control process, for example, when a radio command signal is input to the controller 20 via a radio communication device which is not illustrated, the motion of the robot 2 is controlled by driving a plurality of joint actuators 25 in accordance with the radio command signal.

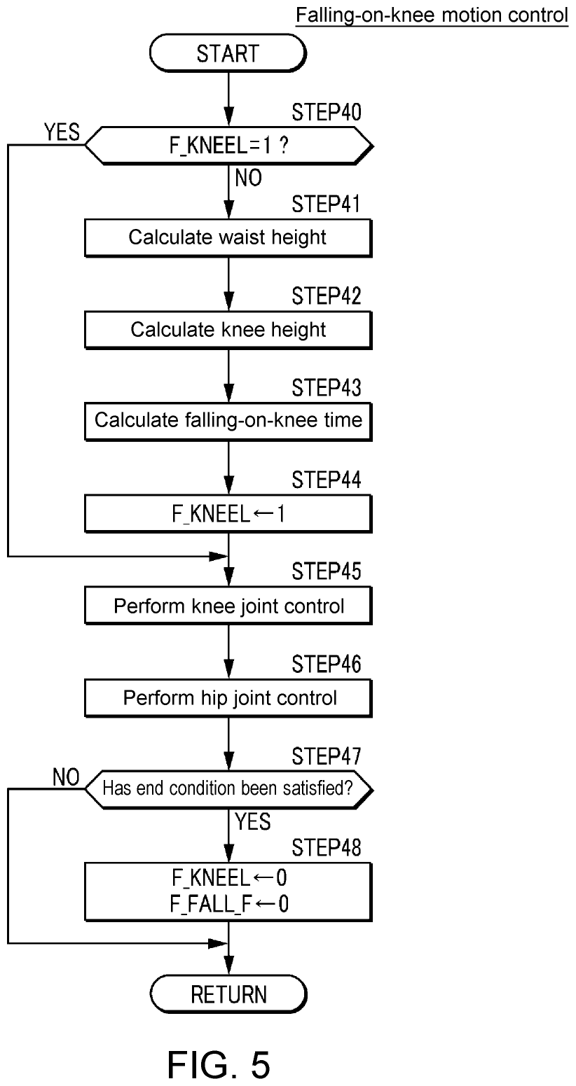

The falling-on-knee motion control process (STEP3 in FIG. 3) will be described below with reference to FIG. 5. As illustrated in the drawing, first, it is determined whether a falling-on-knee motion control flag F_KNEEL is set to “1” (STEP40 in FIG. 5).

When the result of determination is positive (YES in STEP40 in FIG. 5), that is, when the falling-on-knee motion control process has been performed at a control time previous to the previous control time, a knee joint control process which will be described later is performed (STEP46 in FIG. 5).

On the other hand, when the result of determination is negative (NO in STEP40 in FIG. 5), that is, when the current control time is a first control time of the falling-on-knee motion control process, a waist height of the robot 2 is calculated on the basis of the result of support leg determination and the detection signals from the sensors 22 and 23 (STEP41 in FIG. 5). The waist height corresponds to a height from the floor surface (that is, a tiptoe of the foot 13 of the robot 2) to the waist of the robot 2.

Subsequently, a knee height of the robot 2 is calculated on the basis of the result of support leg determination and the detection signals from the sensors 22 and 23 (STEP 42 in FIG. 5). The knee height corresponds to a height from the floor surface to the knee joint mechanism 15 of the robot 2.

Then, a falling-on-knee time is calculated (STEP43 in FIG. 5). The falling-on-knee time (a contact time) is an estimated value of the time from the current time point to a time point at which the tip of the knee joint mechanism 15 of the robot 2 comes into contact with the floor surface, and is calculated on the basis of the knee height of the robot 2 and a rate of change of the knee height.

Thereafter, in order to represent that the falling-on-knee motion control process is being performed, the falling-on-knee motion control flag F_KNEEL is set to “1” (STEP44 in FIG. 5).

In this way, when the falling-on-knee motion control flag F_KNEEL is set to “1,” or when the above-mentioned result of determination is positive (YES in STEP40 in FIG. 5) and the falling-on-knee motion control process has been performed at a control time previous to the previous control time, a knee joint control process is performed subsequent thereto (STEP45 in FIG. 5).

In the knee joint control process, when the robot 2 is supported by two legs, the motion state of the joint actuator 25 is controlled such that the knee joint angle becomes a predetermined falling-on-knee angle while the falling-on-knee time elapses on the basis of the falling-on-knee time and the knee joint angle of the support leg at the current time point. The predetermined falling-on-knee angle (a first predetermined angle) is stored in the ROM of the controller 20, and is preset to an optimal angle (an acute angle) when the robot 2 falls on its knee, that is, when the tip of the knee joint mechanism 15 comes into contact with the floor surface.

When the robot 2 is supported by one leg, the motion state of the joint actuator 25 for driving the knee joint mechanism 15 on the support leg side is controlled in the same way as described above. At the same time, the joint actuator 25 for driving the knee joint mechanism 15 on an idling leg side is controlled such that the knee joint angle on the idling leg side change to follow the joint angle on the support leg side.

Subsequently, a hip joint control process is performed (STEP46 in FIG. 5). In the hip joint control process, the motion states of two joint actuators 25 and 25 for driving two hip joint mechanisms 14 and 14 are controlled such that the vertically projected position of the center of gravity of the upper body (the base body 3 and the head 6) of the robot 2 is located inside the support basal surface of the robot 2 during execution of the falling-on-knee motion control process.

Then, it is determined whether an ending condition of the falling-on-knee motion control process has been satisfied (STEP47 in FIG. 5). In this case, when the tip of the knee joint mechanism 15 of the support leg of the robot 2 comes into contact with the floor surface, the vertically projected position of the center of gravity of the upper body of the robot 2 is located inside the support basal surface of the robot 2, and the absolute value of the rate of change of the total center of gravity DGC_t of the robot 2 is equal to or less than a predetermined threshold value, it is determined that the ending condition of the falling-on-knee motion control process has been satisfied. Otherwise, it is determined that the ending condition of the falling-on-knee motion control process has not been satisfied.

When the result of determination is negative (NO in STEP47 in FIG. 5) and the ending condition of the falling-on-knee motion control process has not been satisfied, the process flow ends without any change.

On the other hand, when the result of determination is positive (YES in STEP47 in FIG. 5) and the ending condition of the falling-on-knee motion control process has been satisfied, the two flags F_KNEEL and F_FALL_F described above are set to “0” to represent that fact (STEP48 in FIG. 5) and then the process flow ends.

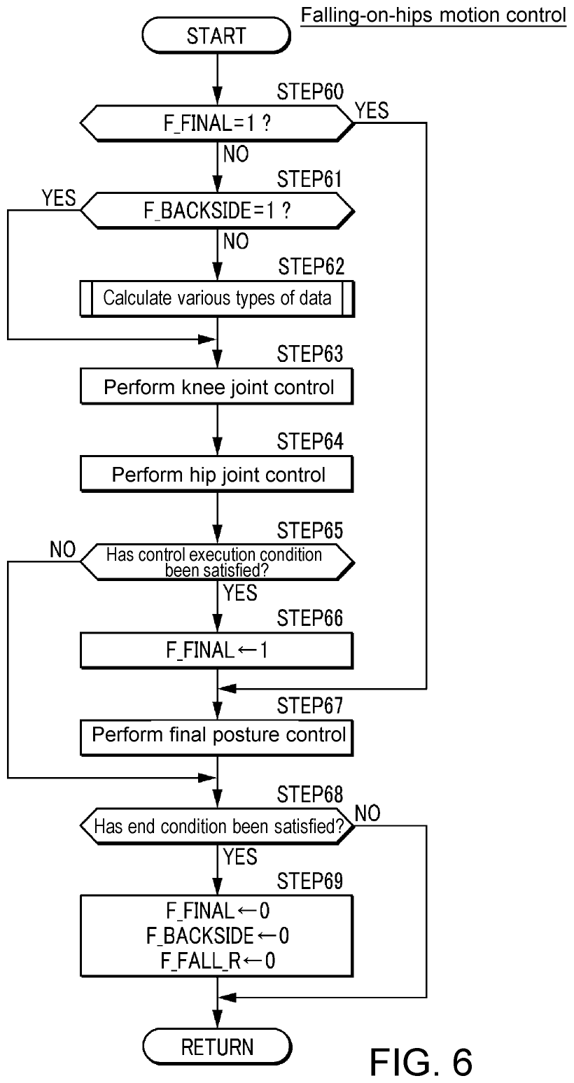

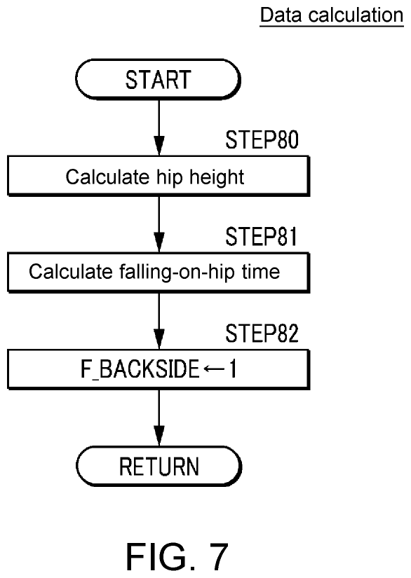

The falling-on-hips motion control process will be described below with reference to FIGS. 6 and 7. As illustrated in the drawings, first, it is determined whether a final posture control flag F_FINAL is set to “1” (STEP60 in FIG. 6).

When the result of determination is positive (YES in STEP60 in FIG. 6), that is, when the final posture control process which will be described later has been performed at a control time previous to the previous control time, the final posture control process (STEP67 in FIG. 6) is performed.

On the other hand, when the result of determination is negative (NO in STEP60 in FIG. 6), it is determined whether falling-on-hips motion control flag F_BACKSIDE is set to “1” (STEP61 in FIG. 6).

When the result of determination is positive (YES in STEP61 in FIG. 6), that is, when the falling-on-hips motion control process has been performed at the control time previous to the previous control time, the knee joint control process which will be described later (STEP63 in FIG. 6) is performed.

On the other hand, when the result of determination is negative (NO in STEP61 in FIG. 6), that is, when the current control time is a first control time of the falling-on-hips motion control process, a data calculating process is performed (STEP62 in FIG. 6). The data calculating process includes calculating various types of data as will be described below, and is performed as illustrated in FIG. 7.

In the data calculating process, first, as illustrated in the drawing, a hip height of the robot 2 is calculated on the basis of the result of support leg determination and the detection signals from the sensors 22 and 23 (STEP80 in FIG. 7). The hip height corresponds to a height from the floor surface (that is, a heel of the robot 2) to the hips of the robot 2.

Subsequently, a falling-on-hips time is calculated (STEP81 in FIG. 7). The falling-on-hips time (a contact time) is an estimated value of a time from the current time point to a time point at which the tip of the hips of the robot 2 comes into contact with the floor surface, and is calculated on the basis of the hip height of the robot 2 and a rate of change of the hip height.

Thereafter, in order to represent that the falling-on-hips motion control process is being performed, the falling-on-hips motion control flag F_BACKSIDE is set to “1” (STEP82 in FIG. 7), and then the process flow ends.

Referring back to FIG. 6, when the data calculating process is performed as described above, or when the result of determination is positive (YES in STEP61 in FIG. 6) and the falling-on-hips motion control process has been performed at the control time previous to the previous control time, the knee joint control process is performed subsequently thereto (STEP63 in FIG. 6).

In the knee joint control process, when the robot 2 is supported by two legs, the motion state of the joint actuator 25 is controlled such that the knee joint angle becomes a predetermined falling-on-hips motion angle while the falling-on-hips time elapses on the basis of the falling-on-hips time and the knee joint angle of the support leg at the current time point. The predetermined falling-on-hips motion angle is stored in the ROM of the controller 20, and is preset to an optimal angle when the robot 2 falls on its hips, that is, when the tip of the hips comes into contact with the floor surface.

When the robot 2 is supported by one leg, the motion state of the joint actuator 25 for driving the knee joint mechanism 15 on the support leg side is controlled in the same way as described above. At the same time, the joint actuator 25 for driving the knee joint mechanism 15 on the idling leg side is controlled such that the knee joint angle on the idling leg side changes to follow the joint angle on the support leg side.

Subsequently, the hip joint control process is performed (STEP64 in FIG. 6). In the hip joint control process, the motion states of two joint actuators 25 and 25 for driving two hip joint mechanisms 14 and 14 are controlled such that the vertically projected position of the center of gravity of the upper body of the robot 2 is located inside the support basal surface of the robot 2 during execution of the falling-on-hips motion control process.

Then, it is determined whether an execution condition of the final posture control process has been satisfied (STEP65 in FIG. 6). In this determination process, on the basis of the detection signals from the sensors 22 and 23, it is determined that the execution condition of the final posture control process has been satisfied when one of the following two conditions (f1) and (f2) has been satisfied, and it is determined that the execution condition of the final posture control process has not been satisfied otherwise.

(f1) There is a possibility of interference between the upper body of the robot 2 and the tip of the knee joint mechanism 15. (f2) The hip joint angle is less than a predetermined lower-limit angle. The predetermined lower-limit angle (a second predetermined angle) corresponds to a lower limit value of the hip joint angle within a movable range of the hip joint mechanism 14.

When the result of determination is negative (NO in STEP65 in FIG. 6) and the execution condition of the final posture control process has not been satisfied, a process of determining whether an ending condition of the falling-on-hips motion control process has been satisfied is performed (STEP68 in FIG. 6).

On the other hand, when the result of determination is positive (YES in STEP65 in FIG. 6) and the execution condition of the final posture control process has been satisfied, or when the result of determination is positive (YES in STEP60 in FIG. 6) and the final posture control process has been performed at the control time previous to the previous control time, the final posture control process is performed subsequently (STEP67 in FIG. 6).

In the final posture control process, the motion state of the joint actuator 25 is controlled such that the knee joint angle of the robot 2 increases while the hips of the robot 2 comes into contact with the floor surface. When the vertically projected position of the center of gravity of the upper body of the robot 2 is located outside the support basal surface of the robot 2 during execution of the final posture control process, the motion states of two joint actuators 25 and 25 are controlled such that the vertically projected position is located inside the support basal surface. In this embodiment, the final posture control process corresponds to second knee joint control and second hip joint control.

When the final posture control process has been performed as described above, or when the result of determination is negative (NO in STEP65 in FIG. 6) and the execution condition of the final posture control process has not been satisfied, it is subsequently determined whether an ending condition of the falling-on-hips motion control process has been satisfied (STEP68 in FIG. 6).

In this case, when the tip of the hips of the robot 2 comes into contact with the floor surface, the vertically projected position of the center of gravity of the upper body of the robot 2 is located inside the support basal surface of the robot 2, and the absolute value of the rate of change of the total center of gravity DGC_t of the robot 2 is equal to or less than a predetermined threshold value, it is determined that the ending condition of the falling-on-hips motion control process has been satisfied. Otherwise, it is determined that the ending condition of the falling-on-hips motion control process has not been satisfied.

When the result of determination is negative (NO in STEP68 in FIG. 6) and the ending condition of the falling-on-hips motion control process has not been satisfied, the process flow ends without any change.

On the other hand, when the result of determination is positive (YES in STEP68 in FIG. 6) and the ending condition of the falling-on-hips motion control process has been satisfied, the three flags F_FINAL, F_BACKSIDE, and F_FALL_R described above are set to “0” (STEP69 in FIG. 6) and then the process flow ends.

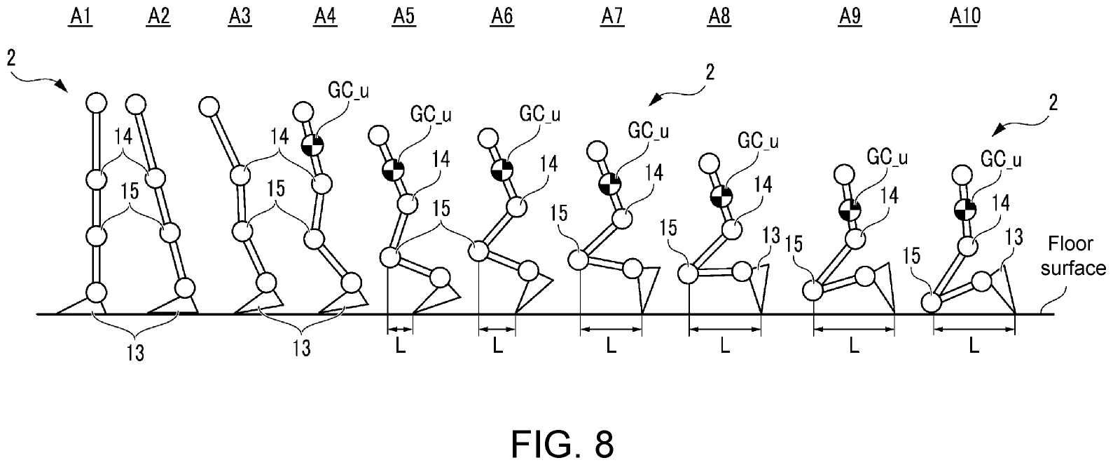

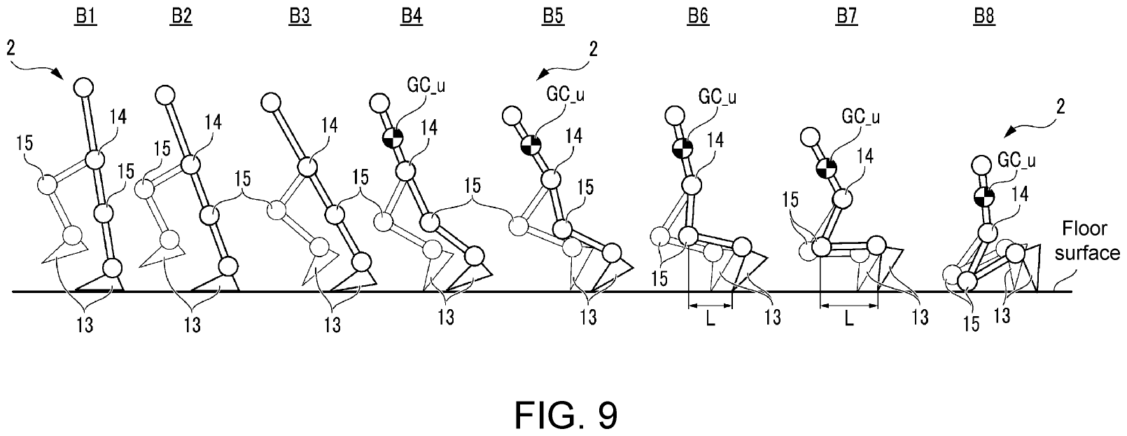

An example of a motion of the robot 2 when the falling-on-knee motion control process and the falling-on-hips motion control process are performed as described above will be described below. First, an example of a motion when the robot 2 enters the forward fall start state and thus the falling-on-knee motion control process is performed will be described with reference to FIGS. 8 and 9.

In FIG. 8, reference signs of the elements of the robot 2 are appropriately omitted for the purpose of easy understanding. In the drawing, L denotes a length of the support basal surface in the X-axis direction. This is true of FIG. 9 or the like which will be described later.

As illustrated in FIG. 8, when the posture of the robot 2 is bent forward from a standing posture A1 which is supported by two legs in the order of postures A2 to A5 due to an external force or the like, the predicted center of gravity GC _f is located outside the support basal surface at the time at which the robot 2 assumes the posture A5. Accordingly, the forward fall start state flag F_FALL_F is set to “1” and thus the falling-on-knee motion control process starts.

After the falling-on-knee motion control process has started, the knee joint angle of the robot 2 changes to be a predetermined falling-on-knee angle as indicated by postures A6 to A8 in the drawing with execution of the knee joint control process. At the same time, with execution of the hip joint control process, the upper body rotates rearward about the hip joint mechanism 14 (clockwise in the drawing) such that the vertically projected position of the center of gravity GC_u of the upper body of the robot 2 is located inside the support basal surface of the robot 2.

In the state in which the tip of the knee joint mechanism 15 of the robot 2 comes into contact with the floor surface as indicated by a posture A10, the knee joint angle becomes a predetermined falling-on-knee angle and the vertically projected position of the center of gravity GC_u of the upper body of the robot 2 is located inside the support basal surface of the robot 2. Accordingly, the falling-on-knee motion control process ends at the time at which the robot 2 assumes the posture A10.

On the other hand, as illustrated in FIG. 9, when the robot 2 is bent forward from a posture B1 supported by one leg in the order of postures B2 to B5 while waling forward, the predicted center of gravity GC _f is located outside the support basal surface at the time at which the robot 2 assumes the posture B5 and the forward fall start state flag F_FALL_F is set to “1”. Accordingly, the falling-on-knee motion control process starts.

After the falling-on-knee motion control process has started, the knee joint angle of the robot 2 changes to be a predetermined falling-on-knee angle as indicated by postures B6 to B8 in the drawing with execution of the knee joint control process. At the same time, with execution of the hip joint control process, the upper body rotates rearward about the hip joint mechanism 14 (clockwise in the drawing) such that the vertically projected position of the center of gravity GC_u of the upper body of the robot 2 is located inside the support basal surface of the robot 2.

Then, in a state in which the tip of the knee joint mechanism 15 on the support leg side of the robot 2 is in contact with the floor surface as indicated by the posture B8, the knee joint angle is a predetermined falling-on-knee angle and the vertically projected position of the center of gravity GC_u of the upper body of the robot 2 is located inside the support basal surface of the robot 2. Accordingly, at the time at which the robot 2 assumes the posture B8, the falling-on-knee motion control process ends.

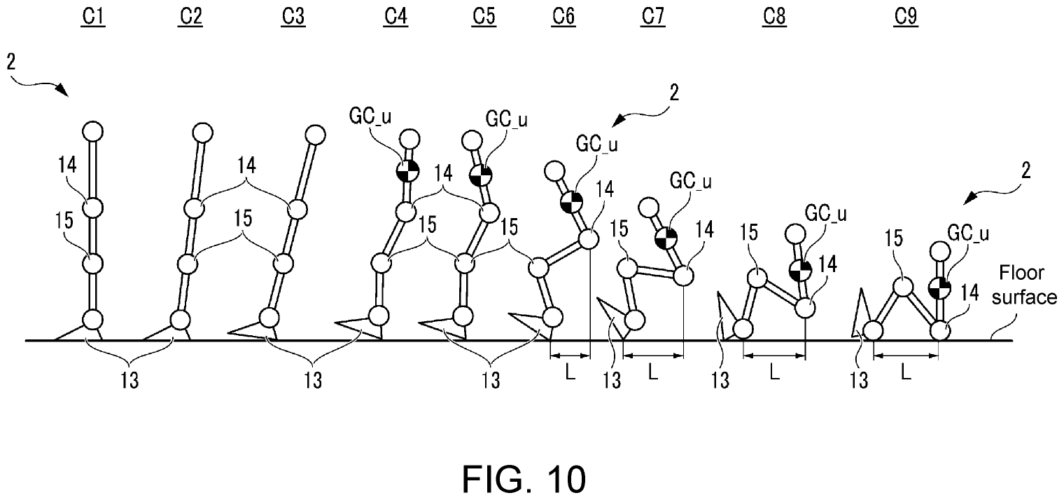

An example of a motion when the robot 2 enters the rearward fall start state and thus the falling-on-hips motion control process is performed will be described below. First, when the posture of the robot 2 changes from the standing posture C1 supported by two legs to the rearward fall start state in the order of postures C2 to C3 due to an external force or the like as illustrated in FIG. 10, the predicted center of gravity GC _f is located outside the support basal surface at the time at which the robot 2 assumes the posture C3. Accordingly, the forward fall start state flag F_FALL_F is set to “1” and thus the falling-on-hips motion control process starts.

After the falling-on-hips motion control process has started, the knee joint angle of the robot 2 changes to be a predetermined falling-on-hips angle as indicated by postures C4 to C8 in the drawing with execution of the knee joint control process. At the same time, with execution of the hip joint control process, the upper body rotates forward about the hip joint mechanism 14 (counterclockwise in the drawing) such that the vertically projected position of the center of gravity GC_u of the upper body of the robot 2 is located inside the support basal surface of the robot 2.

Then, in the state in which the tip of the hips of the base body 3 of the robot 2 comes into contact with the floor surface as indicated by a posture C9, the knee joint angle is the predetermined falling-on-hips angle and the vertically projected position of the center of gravity GC_u of the upper body of the robot 2 is located inside the support basal surface of the robot 2. Accordingly, at the time at which the robot 2 assumes the posture C9, the falling-on-hips motion control process ends.

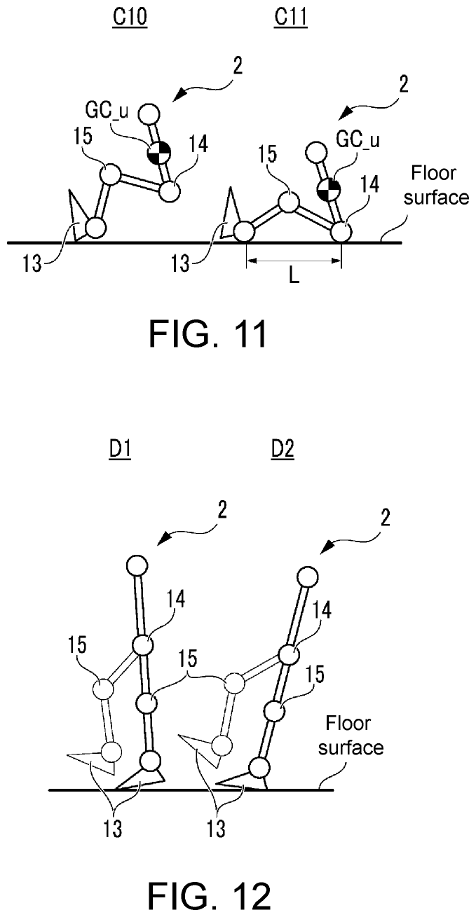

For example, when one of the above-mentioned execution conditions (f1) and (f2) of the final posture control process has been satisfied in a state in which the robot 2 is in the posture C7 during execution of the falling-on-hips motion control process, the final posture control process starts. Therewith, the robot 2 is controlled such that the knee joint angle increases from the posture C10 illustrated in FIG. 11 to the posture C11 in which the hips come into contact with the floor surface.

At the same time, when the vertically projected position of the center of gravity of the upper body of the robot 2 is located outside the support basal surface of the robot 2, the robot 2 is controlled such that the vertically projected position is located inside the support basal surface. Then, at the time at which the robot 2 assumes the posture C10, the final posture control process and the falling-on-hips motion control process end.

As illustrated in FIG. 12, when the total center of gravity of the whole body of the robot moves rearward due to an external force or the like and thus the robot 2 changes its posture from a posture D1 to a posture D2 during walking forward of the robot 2, the robot 2 may further change from the posture D2 to the posture C3 illustrated in FIG. 10. In this case, by performing the falling-on-hips motion control process as described above, the posture of the robot 2 changes from the posture C4 to the posture C8.

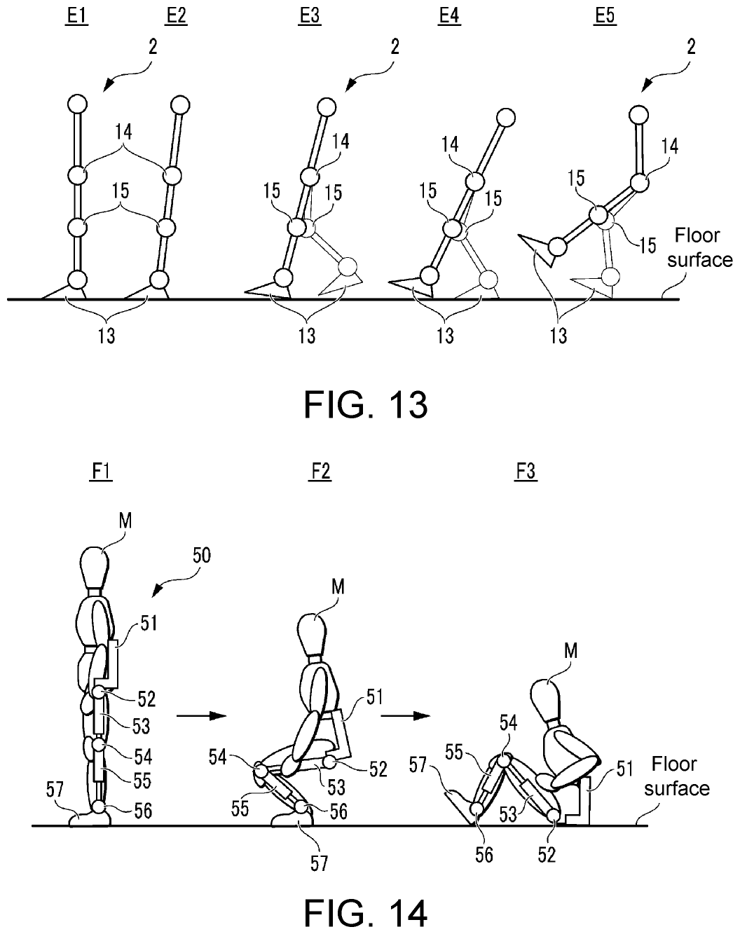

In addition, when the robot 2 starts walking rearward from a standing posture E1 supported by two legs and the posture changes from a posture E2 to a posture E5 as illustrated in FIG. 13, the robot 2 may further change its posture from the posture E5 to the posture C3 illustrated in FIG. 10. In this case, by performing the falling-on-hips motion control process as described above, the posture of the robot 2 also changes from the posture C4 to the posture C8.

As described above, with the control device 1 according to this embodiment, when the robot 2 is in the forward fall start state in the motion control process illustrated in FIG. 3, the falling-on-knee motion control process (FIG. 5) is performed. In the falling-on-knee motion control process, a time from a control start time point to a time point at which the tip of the knee joint mechanism 15 of the support leg comes into contact with the floor surface is calculated as a falling-on-knee time.

Then, in the knee joint control process (STEP45) of the falling-on-knee motion control process, the motion state of the joint actuator 25 is controlled such that the knee joint angle of the support leg becomes a predetermined falling-on-knee angle until the falling-on-knee time elapses on the basis of the falling-on-knee time and the knee joint angle of the support leg at the current time point. Accordingly, when the robot 2 falls forward, the knee joint angle of the support leg becomes the predetermined falling-on-knee angle and thus the robot 2 is in a state in which the tip of the knee joint mechanism 15 of the support leg comes into contact with the floor surface while falling on its knee as illustrated in FIGS. 8 to 9.

In the hip joint control process (STEP46) of the falling-on-knee motion control process, the motion states of two joint actuators 25 and 25 are controlled such that the vertically projected position of the center of gravity of the upper body of the robot 2 is located inside the support basal surface of the robot 2. Accordingly, the upper body of the robot 2 rotates rearward about the hip joint mechanism 14.

Through the above-mentioned control processes, the robot 2 falls on its knee on the floor surface in a state in which the knee joint angle of the support leg becomes the predetermined falling-on-knee angle. Accordingly, in comparison with a case in which a hand comes into contact with the floor surface as in the related art, it is possible to shorten a length of a moment arm and to reduce kinetic energy at the time of contact. As a result, it is possible to decrease damage at the time of falling. Since the robot 2 falls on its knee on the floor surface in a state in which the vertically projected position of the center of gravity of the upper body is located inside the support basal surface of the robot 2, it is possible to secure a stable posture thereafter.

On the other hand, when the robot 2 is in the rearward fall start state, the falling-on-hips motion control process (FIG. 6) is performed. In the falling-on-hips motion control process, a time from the control start time point to the time point at which the tip of the hips of the base body 3 comes into contact with the floor surface is calculated as a falling-on-hips time. Then, in the knee joint control process (STEP63) of the falling-on-hips motion control process, the motion state of the joint actuator 25 is controlled such that the knee joint angle of the support leg becomes a predetermined falling-on-hips angle until the falling-on-hips time elapses on the basis of the falling-on-hips time and the knee joint angle of the support leg at the current time point.

In the hip joint control process (STEP64) of the falling-on-hips motion control process, the motion states of two joint actuators 25 and 25 are controlled such that the vertically projected position of the center of gravity of the upper body of the robot 2 is located inside the support basal surface of the robot 2. Accordingly, the upper body of the robot 2 rotates forward about the hip joint mechanism 14.

Through the above-mentioned control processes, the tip of the hips of the base body 3 comes into contact with the floor surface in a state in which the knee joint angle of the support leg becomes the predetermined falling-on-hips angle and the vertically projected position of the center of gravity of the upper body of the robot 2 is located inside the support basal surface of the robot 2 when the robot 2 falls rearward. Accordingly, in comparison with a case in which a hand comes into contact with the floor surface as in the related art, it is possible to shorten a length of a moment arm and to reduce kinetic energy at the time of contact. As a result, it is possible to decrease damage at the time of falling.

Since the robot 2 falls on its hips on the floor surface in a state in which the vertically projected position of the center of gravity of the upper body is located inside the support basal surface of the robot 2, it is possible to secure a stable posture thereafter.

In addition, when there is a possibility of interference between the upper body of the robot 2 and the tip of the knee joint mechanism 15 or the hip joint angle is less than a predetermined lower-limit angle during execution of the falling-on-hips motion control process, the final posture control process (STEP67) is performed. In the final posture control process, the driving state of the joint actuator 25 is controlled such that the knee joint angle increases. In addition, when the vertically projected position of the center of gravity of the upper body of the robot 2 is located outside the support basal surface of the robot 2, control is performed such that the vertically projected position is located inside the support basal surface.

Accordingly, when there is a possibility of interference between the upper body of the robot 2 and the tip of the knee joint mechanism 15, it is possible to avoid the possibility. On the other hand, when the hip joint angle is less than the predetermined lower-limit angle, it is possible to decrease damage of the hip joint mechanism 14.

In the above-mentioned embodiment, the control device 1 according to the disclosure is applied to a humanoid robot 2, but the control device according to the disclosure is not limited thereto and can be applied to any robot as long as the robot includes a base body including hips, a lower leg portion extending from the base body via a hip joint and including a movable link including a knee joint, a hip joint driving part, and a knee joint driving part and can perform a walking motion for walking on a walking surface by driving the hip joint and the shin joint using the hip joint driving part and the knee joint driving part.

For example, the control device according to the disclosure may be applied to an assist robot 50 illustrated in FIG. 14. As illustrated in the drawing, the assist robot 50 is of a type which is attached to a user M and assists a walking motion of the user M. The assist robot 50 includes a base body 51, a hip joint mechanism 52, a thigh link member 53, a knee joint mechanism 54, a shin link member 55, an ankle joint mechanism 56, and a grounding member 57.

The base body 51 includes hips that are fixed to a waist of the user M and cover hips of the user M and is configured to change an angle about the thigh link member 53, that is, a hip joint angle, using the hip joint mechanism 52. Joint actuators which are not illustrated are provided in the assist robot 50, and the hip joint angle is changed by causing the joint actuators to drive the hip joint mechanism.

When the hip joint angle is changed in this way, that is, when the angle of the base body 51 with respect to the thigh link member 53 is changed, the base body 51 is fixed to the waist of the user M and thus the angle of the upper body of the user M is changed relative to the thigh link member 53.

The thigh link member 53 is configured to change an angle with respect to the shin link member 55, that is, a knee joint angle, using the knee joint mechanism 54. Joint actuators which are not illustrated are provided in the assist robot 50, and the knee joint angle is changed by causing the joint actuators to drive the knee joint mechanism.

A controller such as the above-mentioned controller 20 and various sensors such as the above-mentioned various sensors 21 to 24 are provided in the assist robot 50.

With the control device for the assist robot 50 having the above-mentioned configuration, the same motion control process as described above with reference to FIG. 3 is performed by the control device. Accordingly, when the user M and the assist robot 50 are in the forward fall start state, the same falling-on-knee motion control process as illustrated in FIG. 5 is performed.

On the other hand, when the user M and the assist robot 50 are in the rearward fall start state, the same falling-on-hips motion control process as illustrated in FIG. 6 is performed. Accordingly, for example, when the user M and the assist robot 50 change from a standing posture F1 supported by two legs to the rearward fall start state due to, for example, an external force as illustrated in FIG. 14, the falling-on-hips motion control process starts.

Accordingly, after the falling-on-hips motion control process has started, the knee joint angle of the assist robot 50 changes to be a predetermined falling-on-hips angle as indicated by a posture F2 in the drawing. At the same time, the base body 51 rotates forward about the hip joint mechanism (counterclockwise in the drawing) such that the vertically projected position of the center of gravity of the upper body including the upper body of the user M and the base body 51 of the assist robot 50 is located in the support basal surface of the user M wearing the assist robot 50.

Then, as indicated by a posture F3, in the state in which the tip of the hips of the base body 51 of the assist robot 50 is in contact with the floor surface, the knee joint angle becomes a predetermined falling-on-hips angle and the vertically projected position of the center of gravity of the upper body is located inside the support basal surface of the user M wearing the assist robot 50.

With the control device for the assist robot 50 having the above-mentioned configuration, the same operations and advantages as in the control device 1 according to the embodiment can be achieved.

In the embodiment, the foot pressure sensors 21, the motion sensors 22, and the joint angle sensors 23 are used as a motion state acquiring unit, but the motion state acquiring unit in the disclosure is not limited thereto as long as it can acquire motion states of the base body and the lower leg portion of the robot. For example, a force sensor, a gyro sensor, and an acceleration sensor may be used as the motion state acquiring unit, or a combination of the sensors 21 to 23 therewith may be used.

In the embodiment, the joint actuators 25 are used as a hip joint driving part or a knee joint driving part, but the hip joint driving part or the knee joint driving part in the disclosure is not limited thereto as long as it can drive the hip joint or the knee joint. For example, a hydraulic actuator may be used as the hip joint driving part or the knee joint driving part.

With this control device for a robot, when it is determined that the robot is in the fall start state in which the robot starts to fall in one direction of the forward and rearward directions, a knee joint control for controlling a knee joint angle which is a joint angle of the knee joint via the knee joint driving part is performed such that the portion of the one direction side of the knee joint and the hip joint comes into contact with the walking surface. The hip joint control for controlling a hip joint angle which is a joint angle of the hip joint via the hip joint driving part is performed such that the center of gravity of the upper part which includes the base body and is higher than the base body moves in the direction opposite to the one direction after the knee joint control has started.

Accordingly, since the knee joint or the hip joint comes in contact with a walking surface when the robot falls in one of a forward direction and a rearward direction, it is possible to shorten a length of a moment arm and to reduce kinetic energy at the time of contact in comparison with a case in which hands come into contact with a walking surface as in the related art. As a result, it is possible to decrease damage when the robot falls. In addition, since the center of gravity of the upper part moves in the direction opposite to the one direction after the hip joint control has started, it is possible to secure a stable posture after the front part in the one direction has come into contact with the walking surface.

A second embodiment of the disclosure provides the control device 1 for a robot 2 according to the first embodiment, wherein the hip joint control unit is configured to control the hip joint angle such that a vertically projected position of the center of gravity of the upper part is located in a support basal surface of the robot 2 while performing the hip joint control.

With this control device for a robot, since the hip joint angle is controlled such that the vertically projected position of the center of gravity of the upper part is located in the support basal surface of the robot during execution of the hip joint control, it is possible to reduce an amount of movement of the upper part in a falling direction and to secure a stable posture after the portion of the one direction side has come into contact with the walking surface.

A third embodiment of the disclosure provides the control device 1 for a robot 2 according to the first or second embodiment, wherein the motion state acquiring unit is configured to acquire a height of the portion of the one direction side from the walking surface (for example, a hip height) as the motion state, the control device 1 further includes a contact time estimating unit (a controller 20, STEP43 and STEP81) configured to estimate a time from a start time point of the knee joint control to a time point at which the portion of the one direction side comes into contact with the walking surface as a contact time (a falling-on-knee time, a falling-on-hips time) in accordance with the height of the portion of the one direction side from the walking surface, and the knee joint control unit is configured to control the knee joint angle such that the knee joint angle becomes a first predetermined angle (a predetermined falling-on-knee angle) after the knee joint control has started and before the contact time has elapsed.

With this control device for a robot, a time from a start time point of the hip joint control to a time point at which the portion of the one direction side comes into contact with the walking surface is estimated as the contact time in accordance with a height of the portion of the one direction side from the walking surface. Since the knee joint angle is controlled such that the knee joint angle becomes the first predetermined angle after the hip joint control has started and before the contact time has elapsed, the knee joint can be brought into contact with the walking surface in a state in which the knee joint angle is the first predetermined angle. Accordingly, by appropriately setting the first predetermined angle, it is possible to secure a stable posture after the portion of the one direction side has come into contact with the walking surface.

A fourth embodiment of the disclosure provides the control device 1 for a robot 2 according to any one of the first to third embodiments, further including a second knee joint control unit (a controller 20, STEP67) configured to perform a second knee joint control for controlling the knee joint angle via the knee joint driving part such that the knee joint angle increases when a preset control execution condition is satisfied after the knee joint control has started because the robot is in the fall start state of rearward.

With this control device for a robot, when a preset control execution condition has been satisfied after the hip joint control has started, a second knee joint control for controlling the knee joint angle via the knee joint driving part is performed such that the knee joint angle increases. Accordingly, by appropriately setting the control execution condition, it is possible to secure a stable posture at a time at which the hip comes into contact with the walking surface.

A fifth embodiment of the disclosure provides the control device 1 for a robot 2 according to the fourth embodiment, wherein the control execution condition is one of a first condition that there is a possibility of interference between the upper part and the knee joint and a second condition that the hip joint angle is less than a second predetermined angle (a predetermined lower-limit angle).

With this control device for a robot, when one of the first condition that there is a possibility of interference between the upper part and the knee joint and the second condition that the hip joint angle is less than the second predetermined angle has been satisfied, the second knee joint control is performed such that the knee joint angle increases. When the second knee joint control is performed such that the knee joint angle increases in a state in which the first condition has been satisfied in this way, it is possible to prevent interference between the upper part and the knee. When the second knee joint control is performed such that the knee joint angle increases in a state in which the second condition has been satisfied in this way, it is possible to allow the hip joint angle to be equal to or greater than the second predetermined angle. Accordingly, by setting the second predetermined angle to a lower-limit angle within a movable range of the hip joint, it is possible to decrease damage of the hip joint.

A sixth embodiment of the disclosure provides the control device 1 for a robot 2 according to the fourth or fifth embodiment, further including a second hip joint control unit (a controller 20, STEP67) configured to perform a second hip joint control for controlling the hip joint angle via the hip joint driving part such that a vertically projected position of the center of gravity of the upper part is located in a support basal surface of the robot 2 when the vertically projected position of the center of gravity of the upper part departs from the support basal surface of the robot during the performing of the second knee joint control.

With this control device for a robot, when the vertically projected position of the center of gravity of the upper part departs from the support basal surface of the robot during execution of the second knee joint control, a second hip joint control for controlling the hip joint angle via the hip joint driving part is performed such that the vertically projected position of the center of gravity of the upper part is located in the support basal surface of the robot. Accordingly, at the time at which the hip comes into contact with the walking surface, the center of gravity of the upper part can be located in the support basal surface and a stable posture of the upper part can be secured.

A seventh embodiment of the disclosure provides the control device 1 for a robot 2 according to any one of the first to sixth embodiments, wherein the robot 2 is a humanoid robot of which the upper part corresponds to an upper body of a hip of a human body.

With this control device for a robot, the above-mentioned operations and advantages can be achieved in a humanoid robot.

An eighth embodiment of the disclosure provides the control device for a robot 50 according to any one of the first to sixth embodiments, wherein the robot 50 is an assist robot 50 of which the base body 51 is attached to a waist of a user M and which assists the user M with a walking motion.

With this control device for a robot, the above-mentioned operations and advantages can be achieved in an assist robot that assists a user with a walking motion.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A control device for a robot, the robot including a base body having a hip, a lower leg portion extending from the base body via a hip joint and having a movable link including a knee joint, a hip joint driving part, and a knee joint driving part and being able to perform a walking motion for walking on a walking surface by driving the hip joint and the knee joint using the hip joint driving part and the knee joint driving part, the control device comprising:
a motion state acquiring unit configured to acquire motion states of the base body and the lower leg portion;
a determination unit configured to determine whether the robot is in a fall start state in which the robot starts to fall in one direction of a forward direction and a rearward direction on the basis of a result of acquisition of the motion states by the motion state acquiring unit;
a knee joint control unit configured to perform a knee joint control for controlling a knee joint angle which is a joint angle of the knee joint via the knee joint driving part such that a portion of the one direction side of the knee joint and the hip comes into contact with the walking surface when it is determined that the robot is in the fall start state in the one direction; and
a hip joint control unit configured to perform a hip joint control for controlling a hip joint angle which is a joint angle of the hip joint via the hip joint driving part such that a center of gravity of an upper part which includes the base body and which is higher than the base body moves in a direction opposite to the one direction after the knee joint control has started.

2. The control device for a robot according to claim 1, wherein the hip joint control unit is configured to control the hip joint angle such that a vertically projected position of the center of gravity of the upper part is located in a support basal surface of the robot while performing the hip joint control.

3. The control device for a robot according to claim 1, wherein the motion state acquiring unit is configured to acquire a height of the portion of the one direction side from the walking surface as the motion state,
wherein the control device further comprises a contact time estimating unit configured to estimate a time from a start time point of the knee joint control to a time point at which the portion of the one direction side comes into contact with the walking surface as a contact time in accordance with the height of the portion of the one direction side from the walking surface, and
wherein the knee joint control unit is configured to control the knee joint angle such that the knee joint angle becomes a first predetermined angle after the knee joint control has started and before the contact time has elapsed.

4. The control device for a robot according to claim 2, wherein the motion state acquiring unit is configured to acquire a height of the portion of the one direction side from the walking surface as the motion state,
wherein the control device further comprises a contact time estimating unit configured to estimate a time from a start time point of the knee joint control to a time point at which the portion of the one direction side comes into contact with the walking surface as a contact time in accordance with the height of the portion of the one direction side from the walking surface, and
wherein the knee joint control unit is configured to control the knee joint angle such that the knee joint angle becomes a first predetermined angle after the knee joint control has started and before the contact time has elapsed.

5. The control device for a robot according to claim 1, further comprising a second knee joint control unit configured to perform a second knee joint control for controlling the knee joint angle via the knee joint driving part such that the knee joint angle increases when a preset control execution condition is satisfied after the knee joint control has started because the robot is in the fall start state of rearward.

6. The control device for a robot according to claim 5, wherein the control execution condition is one of a first condition that there is a possibility of interference between the upper part and the knee joint and a second condition that the hip joint angle is less than a second predetermined angle.

7. The control device for a robot according to claim 5, further comprising a second hip joint control unit configured to perform a second hip joint control for controlling the hip joint angle via the hip joint driving part such that a vertically projected position of the center of gravity of the upper part is located in a support basal surface of the robot when the vertically projected position of the center of gravity of the upper part departs from the support basal surface of the robot during the performing of the second knee joint control.

8. The control device for a robot according to claim 1, wherein the robot is a humanoid robot of which the upper part corresponds to an upper body of a hip of a human body.

9. The control device for a robot according to claim 1, wherein the robot is an assist robot of which the base body is attached to a waist of a user and which assists the user with a walking motion.
